(19) United States
(12) Patent Application Publication
(10) Pub. No.: US 2025/0042367 A1
(43) Pub. Date: Feb. 6, 2025

(54) FLUID CURTAIN SYSTEM FOR A VEHICLE SENSOR

(71) Applicant: GM Global Technology Operations LLC, Detroit, MI (US)

(72) Inventors: Steven James Jennings, Birmingham, MI (US); Thomas W. Jozwiak, Southgate, MI (US); Chijou Wang, Farmington Hills, MI (US)

(21) Appl. No.: 18/363,571

(22) Filed: Aug. 1, 2023

(51) Int. Cl. B60S 1/56

(52) U.S. Cl. CPC B60S 1/56

(57) ABSTRACT

A fluid curtain system for a vehicle mounted sensor includes a sensor member including a first end, a second end, and a sensing surface. The sensing surface is arranged between the first end and the second end. A fluid curtain generator is arranged at one of the first end and the second end of the sensor member. The fluid curtain generator is operable to generate and direct multiple streams of fluid at the sensor, the multiple streams of fluid forming a fluid curtain across the sensing surface.

### INTRODUCTION

The subject disclosure relates to the art of vehicle sensors and, more particularly, to a fluid curtain system for a vehicle sensor.

Vehicles now include a multitude of sensors. Sensors are used to detect lights from on-coming vehicles, rain, people, and other vehicles. Sensors are mounted in various locations on the vehicle. The mounting location is typically dependent upon the object(s) targeted for sensing. Many of the sensors include a sensing surface that is mounted external to the vehicle. As such, the sensing surface may become coated with foreign objects such as, for example, water, dust, dirt, road debris, tire debris, and the like.

Foreign objects such as dirt and the like on the sensing surface may detract from an overall efficiency of the sensor. As such, many manufacturers include systems for cleaning the sensing surface. The systems may direct jets of air and/or water through nozzles directed onto the sensing surface. Accordingly, it is desirable to provide a system for cleaning a sensor that provides a more complete cleaning of the sensor surface.

### SUMMARY

A fluid curtain system for a vehicle mounted sensor, in accordance with a non-limiting example, includes a sensor member including a first end, a second end, and a sensing surface. The sensing surface is arranged between the first end and the second end. A fluid curtain generator is arranged at one of the first end and the second end of the sensor member. The fluid curtain generator is operable to generate and direct multiple streams of fluid at the sensor, the multiple streams of fluid forming a fluid curtain across the sensing surface.

In addition to one or more of the features described herein the fluid curtain generator includes a body including an edge defining a sensor member receiving zone, the edge including a plurality of fluid outlets through which pass the multiple streams of fluid.

In addition to one or more of the features described herein the body includes a fluid inlet and a fluid passage connecting the fluid inlet to the plurality of fluid outlets.

In addition to one or more of the features described herein the fluid inlet includes a first inlet member and a second inlet member and the fluid passage includes a first passage portion extending from the first inlet member to the plurality of fluid outlets and a second passage portion extending from the second inlet member to the plurality of fluid outlets.

In addition to one or more of the features described herein a valve is connected to the fluid inlet.

In addition to one or more of the features described herein a controller is operatively connected to the valve, the controller selectively opening the valve to generate the fluid curtain across the sensing surface.

In addition to one or more of the features described herein each of the plurality of fluid outlets has a generally rectangular cross-section.

In addition to one or more of the features described herein the plurality of fluid outlets is shaped to direct the multiple streams of fluid at about a 25° across the sensing surface.

In addition to one or more of the features described herein the sensor member defines a LiDAR sensor.

In addition to one or more of the features described herein the sensor member defines a cylindrical member, the sensing surface having an arcuate profile defining a portion of the cylindrical member.

A vehicle, in accordance with a non-limiting example, includes a body including an outer surface and a sensor member mounted to the outer surface of the body. The sensor member includes a first end, a second end, and a sensing surface. The sensing surface is arranged between the first end and the second end. A fluid curtain generator is arranged at one of the first end and the second end of the sensor member. The fluid curtain generator is operable to generate and direct multiple streams of fluid at the sensor. The multiple streams of fluid form a fluid curtain across the sensing surface.

In addition to one or more of the features described herein the fluid curtain generator includes a body including an edge defining a sensor member receiving zone, the edge including a plurality of fluid outlets through which pass the multiple streams of fluid.

In addition to one or more of the features described herein the body includes a fluid inlet and a fluid passage connecting the fluid inlet to the plurality of fluid outlets.

In addition to one or more of the features described herein the fluid inlet includes a first inlet member and a second inlet member and the fluid passage includes a first passage portion extending from the first inlet member to the plurality of fluid outlets and a second passage portion extending from the second inlet member to the plurality of fluid outlets.

In addition to one or more of the features described herein a valve is connected to the fluid inlet.

In addition to one or more of the features described herein a controller is operatively connected to the valve, the controller selectively opening the valve to generate the fluid curtain across the sensing surface.

In addition to one or more of the features described herein each of the plurality of fluid outlets has a generally rectangular cross-section.

In addition to one or more of the features described herein the plurality of fluid outlets is shaped to direct the multiple streams of fluid at about a 25° across the sensing surface.

In addition to one or more of the features described herein the sensor member defines a LiDAR sensor.

In addition to one or more of the features described herein the sensor member defines a cylindrical member, the sensing surface having an arcuate profile defining a portion of the cylindrical member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a sensor having a fluid curtain system, in accordance with a non-limiting example;

FIG. 2 is a perspective glass view of the sensor and fluid curtain system of FIG. 1; and

FIG. 3 is a block diagram illustrating a control system for the fluid curtain system, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

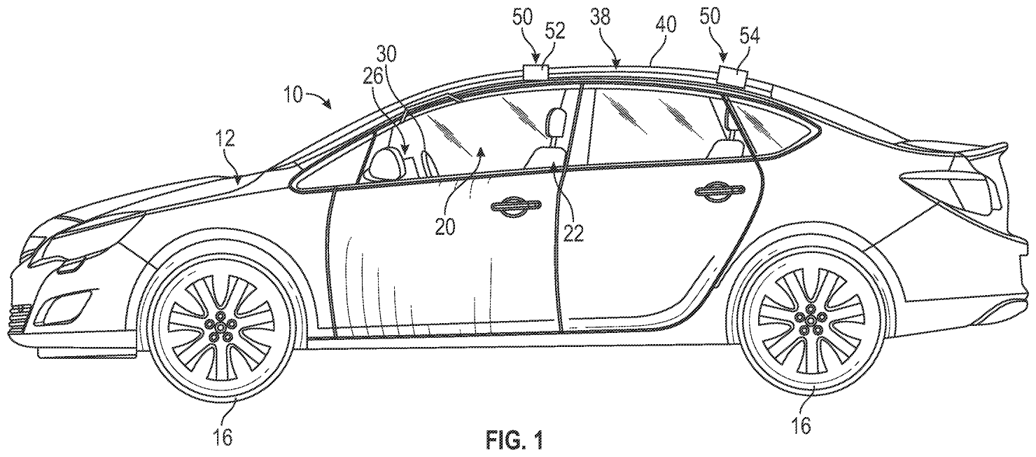

A vehicle, in accordance with a non-limiting example, is indicated generally at 10 in FIG. 1. Vehicle 10 includes a body 12 supported on a plurality of wheels 16. Body 12 includes a passenger compartment 20 within which are arranged a number of seats, such as indicated at 22. Seat 22 is positioned behind an instrument panel 26. A steering wheel 30 is arranged between seat 22 and instrument panel 26. Body 12 defines, in part, a roof 38 having an exterior surface 40. A plurality of sensors 50 is mounted to the exterior surface 40 of roof 38. The number, type, and mounting location of sensors 50 may vary. In a non-limiting example, sensors 50 may include a first LiDAR sensor 52 and a second LiDAR sensor 54. Sensors 50 may include additional LiDAR sensors mounted to roof 38.

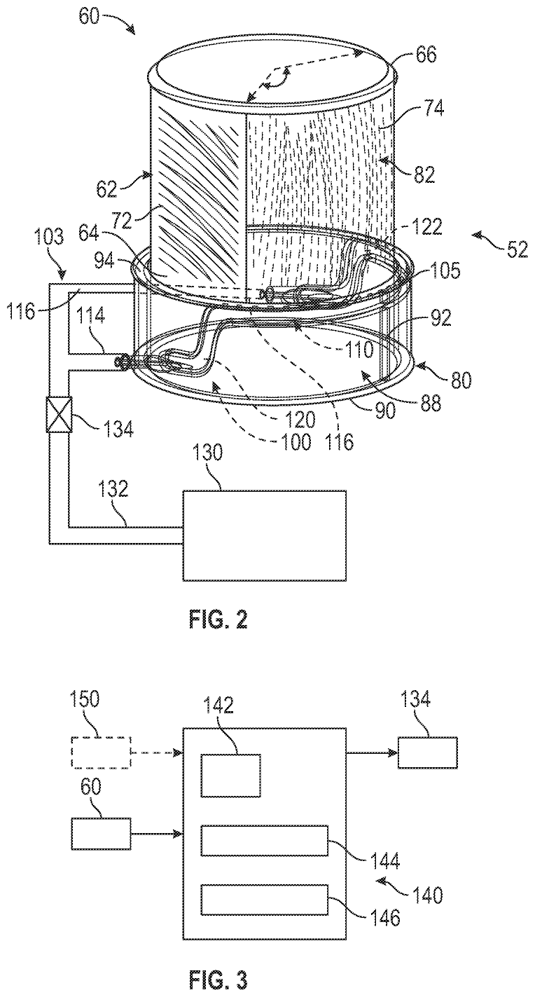

Reference will now follow to FIG. 2 in describing first LiDAR sensor 52 with an understanding that second LiDAR sensor 54 includes similar structure. First LiDAR sensor 52 includes a sensor member 60 having a body 62 including a first end 64 and a second end 66 that is opposite first end 64. Body 62 includes a cylindrical profile having an outer annular surface 72. In a non-limiting example, a portion of outer annular surface 72 defines a sensing surface 74. In a non-limiting example, sensing surface 74 extends across about 160° of outer annular surface 72. Sensing surface 74 defines that portion of sensor body through which sensing waves may be emitted and/or received.

In a non-limiting example, sensor member 60 is connected to a fluid curtain generator 80 at first end 64 of body 62. While shown as being mounted atop fluid curtain generator 80, it should be understood that the relative position of sensor member 60 and fluid curtain generator 80 may vary. As will be detailed herein, fluid curtain generator 80 generates and directs a fluid curtain 82 across sensing surface 74. At this point, it should be understood that the term “fluid curtain” describes multiple streams of fluid that merge with one another and pass over nearly the entirety of sensing surface 74 in order to dislodge and remove any accumulation of detritus.

In a non-limiting example, fluid curtain generator 80 includes a body member 88 having a base 90, an outer annular surface portion 92 and an annular edge 94. Annular edge 94 defines a sensor member receiving zone (not separately labeled). Body member 88 supports a fluid delivery system 100 that generates and discharges the fluid curtain 82 across sensing surface 74. Fluid delivery system 100 includes a fluid inlet 103, a plurality of outlets 105 formed in annular edge 94, and a fluid passage 110 that delivers fluid from fluid inlet 103 to plurality of fluid outlets 105.

In a non-limiting example, fluid inlet 103 includes a first fluid inlet 114 and a second fluid inlet 116 connected to the plurality of fluid outlets 105 through a first passage portion 120 and a second passage portion 122 of fluid passage 110. First passage portion 120 and second passage portion 122 are embedded in body member 88 and are fluidically connected with each other at the plurality of fluid outlets 105. In a non-limiting example, first fluid inlet 114 and second fluid inlet 116 are connected to a source of fluid 130 through a supply conduit 132. In a non-limiting example, source of fluid may supply air to fluid delivery system 100. In another non-limiting example, source of fluid 130 may supply a liquid to fluid delivery system 100. A valve 134 may be arranged in supply conduit 132 between source of fluid 130 and first fluid inlet 114 and second inlet 116. In a non-limiting example, source of fluid 130 is a source of pressurized air. The source of pressurized air may take the form of a pump that delivers pressurized air into fluid curtain generator 80.

In a non-limiting example, fluid curtain generator 80 is connected to a controller 140 as shown in FIG. 3. Controller 140 includes a central processing unit 142, a non-volatile memory 144, and a curtain generating module 146. At this point, while components of controller 140 are shown as being co-located, one or more of the components may be embodied in other systems. Controller 140 receives inputs from sensor member 60 that may indicate a degradation in sensor quality. Other inputs 150 including a manual input, a driving module input and the like may also be employed to activate controller 140. Curtain control module 146 may then open valve 134 and/or activate source of fluid 130 to create a flow of fluid, such as air, to fluid curtain generator 80. The flow of fluid passes through the plurality of outlets 105 forming fluid curtain 82 over sensing surface 74 to remove any detritus, dirt, and the like to improve sensing quality.

In accordance with another exemplary aspect, curtain control module 146 may activate fluid curtain generator 80 based on predetermined time intervals stored in non-volatile memory 144. In a non-limiting example, curtain control module 146 may control source of fluid 130 to deliver fluid to fluid curtain generator at a first flow rate or a second flow rate that is greater than the first flow rate. For example, fluid may be delivered to fluid curtain generator 80 at the first flow rate at all times that vehicle 10 is active in order to maintain a clean sensing surface and an the second rate to remove detritus, and the like. The fluid delivered to fluid curtain generator 80 may be heated in order to maintain sensing surface 74 ice free. At this point, it should be understood that while described in terms of LiDAR sensors, the particular form of sensors may vary as may the type of fluid.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A fluid curtain system for a vehicle mounted sensor comprising:
a sensor member including a first end, a second end, and a sensing surface, the sensing surface being arranged between the first end and the second end; and
a fluid curtain generator arranged at one of the first end and the second end of the sensor member, the fluid curtain generator being operable to generate and direct multiple streams of fluid at the sensor member, the multiple streams of fluid forming a fluid curtain across the sensing surface.

2. The fluid curtain system according to claim 1, wherein the fluid curtain generator includes a body including an edge defining a sensor member receiving zone, the edge including a plurality of fluid outlets through which pass the multiple streams of fluid.

3. The fluid curtain system according to claim 2, wherein the body includes a fluid inlet and a fluid passage connecting the fluid inlet to the plurality of fluid outlets.

4. The fluid curtain system according to claim 3, wherein the fluid inlet includes a first inlet member and a second inlet member and the fluid passage includes a first passage portion extending from the first inlet member to the plurality of fluid outlets and a second passage portion extending from the second inlet member to the plurality of fluid outlets.

5. The fluid curtain system according to claim 3, further comprising a valve connected to the fluid inlet.

6. The fluid curtain system according to claim 5, further comprising a controller operatively connected to the valve, the controller selectively opening the valve to generate the fluid curtain across the sensing surface.

7. The fluid curtain system according to claim 2, wherein each of the plurality of fluid outlets has a generally rectangular cross-section.

8. The fluid curtain system according to claim 2, wherein the plurality of fluid outlets is shaped to direct the multiple streams of fluid at about a 25° across the sensing surface.

9. The fluid curtain system according to claim 1, wherein the sensor member defines a LiDAR sensor.

10. The fluid curtain system according to claim 1, wherein the sensor member defines a cylindrical member, the sensing surface having an arcuate profile defining a portion of the cylindrical member.

11. A vehicle comprising:
a body including an outer surface;
a sensor member mounted to the outer surface of the body, the sensor member including a first end, a second end, and a sensing surface, the sensing surface being arranged between the first end and the second end; and
a fluid curtain generator arranged at one of the first end and the second end of the sensor member, the fluid curtain generator being operable to generate and direct multiple streams of fluid at the sensor member, the multiple streams of fluid forming a fluid curtain across the sensing surface.

12. The vehicle according to claim 11, wherein the fluid curtain generator includes a body including an edge defining a sensor member receiving zone, the edge including a plurality of fluid outlets through which pass the multiple streams of fluid.

13. The vehicle according to claim 12, wherein the body includes a fluid inlet and a fluid passage connecting the fluid inlet to the plurality of fluid outlets.

14. The vehicle according to claim 13, wherein the fluid inlet includes a first inlet member and a second inlet member and the fluid passage includes a first passage portion extending from the first inlet member to the plurality of fluid outlets and a second passage portion extending from the second inlet member to the plurality of fluid outlets.

15. The vehicle according to claim 13, further comprising a valve connected to the fluid inlet.

16. The vehicle according to claim 15, further comprising a controller operatively connected to the valve, the controller selectively opening the valve to generate the fluid curtain across the sensing surface.

17. The vehicle according to claim 12, wherein each of the plurality of fluid outlets has a generally rectangular cross-section.

18. The vehicle according to claim 12, wherein the plurality of fluid outlets is shaped to direct the multiple streams of fluid at about a 25° across the sensing surface.

19. The vehicle according to claim 10, wherein the sensor member defines a LiDAR sensor.

20. The vehicle according to claim 10, wherein the sensor member defines a cylindrical member, the sensing surface having an arcuate profile defining a portion of the cylindrical member.
